(19) United States
(12) Patent Application Publication
(10) Pub. No.: US 2025/0280798 A1
(43) Pub. Date: Sep. 11, 2025

(54) Pet Management System

(71) Applicant: Shenzhen Xuanyuan Star Electronic Technology Co., Ltd., Shenzhen (CN)

(72) Inventor: Shoufeng Huang, Shangluo (CN)

(21) Appl. No.: 19/215,207

(22) Filed: May 21, 2025

Related U.S. Application Data
(63) Continuation-in-part of application No. 29/995,764, filed on Mar. 28, 2025.

(51) Int. Cl. A01K 27/00; A01K 5/02; A01K 15/02; E05F 15/77

(52) U.S. Cl. CPC A01K 27/009; A01K 5/02; A01K 15/025; A01K 27/001; E05F 15/77

(57) ABSTRACT

A pet management system includes a pet collar, which is provided with a controller, a wireless transmission module and a detection module, wherein the controller is electrically connected to the wireless transmission module and the detection module; the controller is connected to a terminal device via the wireless transmission module. The detection module is used to monitor real-time health condition of pets.

### CROSS REFERENCE TO RELATED APPLICATIONS

The present application claims the benefit of U.S. Design patent application Ser. No. 29/995,764 filed on Mar. 28, 2025, titled “Pet Collar”, the contents of which are hereby incorporated by reference.

### TECHNICAL FIELD

The present invention belongs to the technical field of pet products and particularly relates to a pet management system.

### TECHNICAL BACKGROUND

At present, more and more people like to keep pets, and they pay much attention to the health and safety management of their pets. The traditional pet management method mainly relies on the owner's daily observation and regular physical examination of a pet.

However, the traditional management method has limitations. The owner cannot obtain the pet's physiological characteristics data in real time, and it is difficult to detect the pet's health abnormalities in time. For example, the pet is in fever suddenly, abnormal heart rate, etc. And these may delay a treatment in time.

### Invention Content

In order to overcome the deficiencies of the prior art, the present invention provides a pet management system that can monitor the real-time health condition of pets. Once the pet is in an abnormal health condition, a report will be generated in time and sent to pet doctors. Pet doctors and owners can learn the real-time health condition of the pet.

The technical scheme adopted by the present invention for solving the technical problems is as follows:

A pet management system includes a pet collar, which includes a controller, a wireless transmission module and a detection module. The controller is electrically connected to the wireless transmission module and the detection module. The controller is connected to a terminal device via the wireless transmission module. The detection module is used to monitor the health condition of pets.

Further, the pet management system also includes a camera module which is electrically connected to the controller. The controller is provided with a timing module to turn on or turn off the camera module.

Further, the pet management system also includes a global position system module, and the global position system module includes a global position system positioner for determining position.

Further, the pet management system also includes a voice recognition module which includes a microphone and a speaker. The speaker is used to play prerecorded audio recordings, and the microphone is used to record pet sounds.

Further, the pet management system also includes an interaction module which includes a feeder, a toy and an automatic door. The feeder, the toy and the automatic door are respectively provided with a Bluetooth chip, and the feeder, and the toy and the automatic door are connected to the controller via the wireless transmission module.

Further, the pet collar includes a main body, a first strap and a second strap. The first strap and the second strap are arranged on the two sides of the main body. The first strap is provided with a plurality of evenly distributed connection holes along its length direction. The second strap is provided with a connection buckle and a fixing buckle. The connection buckle can be inserted into any one of the connection holes to have the first strap and the second strap connected. The fixing buckle is used to fix the first strap.

Further, the camera module includes a camera exposed on the surface of the pet collar. When a pet wears the pet collar, the camera is located in front of the pet's neck and can record videos or take photos from the first perspective of the pet.

Further, the detection module also includes a motion sensor. When the motion sensor monitors an abnormal moving speed or when the voice recognition module monitors abnormal sounds from the pet, the controller will receive warming signals.

The beneficial effects of the present invention are:

First, in terms of health monitoring, the various sensors in the detection module can obtain the pet's body temperature, pulse and other physiological characteristics in real time. Once an abnormality occurs, a report can be generated in time and sent to a pet doctor, which is helpful for pet health management.

Second, in terms of behavior monitoring, the camera module has functions of recording and live broadcasting, which can monitor a pet's surrounding conditions remotely and in real-time. It can also record videos or take photos from the first perspective of the pet to help their owners know their pets' real-time condition;

Third, in terms of interaction management, the settings of voice recognition module and interaction module support remote voice communication between owners and pets, control of feeders, toys and other equipment, thereby strengthening the interaction between owners and pets;

Fourth, the global position system module makes it easy to track the pet's position. The low-power design of the global position system module extends its battery life. The adjustable collar structure fits most of pets. Thus, the overall intelligence, convenience and efficiency of pet management are greatly improved.

### DESCRIPTION OF FIGURES

FIG. 1 is a principle diagram of a pet management system of the present invention;

FIG. 2 is a principle diagram of an interaction module of the present invention;

FIG. 3 is a schematic diagram of a pet collar of the present invention;

FIG. 4 is a schematic diagram of the pet collar of the present invention from another angle;

### DESCRIPTION OF MARKS IN FIGURES

1—pet collar; 11—main body; 12—first strap; 121—connection hole; 13—second strap; 131—connection buckle; 132—fixing buckle; 14—camera; 15—control switch; 2—detection module.

### DETAILED DESCRIPTION OF THE EMBODIMENTS

The present embodiment only shows an explanation of the present invention, and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it cannot be understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

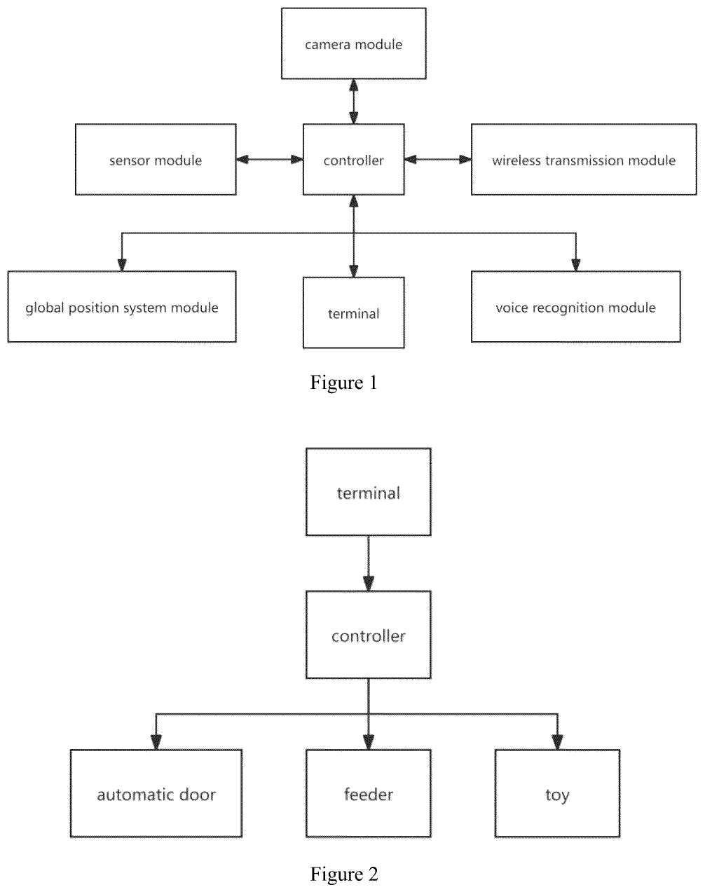

Referring to FIGS. 1 to 4, this embodiment provides a pet management system including a pet collar 1, which is provided with a controller, a wireless transmission module and a detection module 2. The controller is electrically connected to the wireless transmission module and the detection module 2. The controller is connected to a terminal device through the wireless transmission module. The detection module 2 is used to monitor real-time health condition of pets.

Preferably, the terminal device refers to a portable electronic device such as a mobile phone or a tablet. The terminal device is provided with an application. The wireless transmission module can adopt a wireless fidelity transmission module or a Bluetooth module, which is used to connect the terminal device and the controller inside the pet collar 1. The detection module 2 includes various sensors. The various sensors exposed on the surface of the pet collar 1 can detect the pet's body temperature, pulse, respiratory rate, heart rate and other physiological characteristics.

In this embodiment, the detection module 2 transmits the detected physiological characteristics to the controller. The controller transmits the data to the application through the wireless transmission module. The user can check whether the physiological characteristics of the pet are abnormal on the application of the terminal device. When the physiological characteristics displayed of the pet are abnormal, the application will actively generate a report and send the report to the pet doctor through email or short messaging service, so as to follow up the pet's condition in time.

Preferably, the pet management system further includes a camera module. The camera module is electrically connected to the controller. The controller is provided with a timing module used to turn on or off the camera module.

Specifically, the camera module has functions of video acquisition, encoding and network transmission. While capturing video images, the camera module can convert optical images into electrical signals and then convert the electrical signals into digital video signals for subsequent storage, transmission and playback.

The camera module has the functions of recording and live broadcasting. Specifically, when the controller of the pet management system is connected to the application, the user can control the camera module to record the video on the application. The recorded video will be stored in the storage medium of the camera module in a certain format or stored on the terminal device connected to the camera module. The user can view and manage these recorded videos on the application at any time, and perform operations such as playing, deleting, and sharing. In addition, the camera module can encode and process the video signals collected in real time and transmit them to the Internet in real time through the network. Other users can watch the live broadcast content of the device on different devices (such as mobile phones, computers, tablets, etc.) through the corresponding platform or application. The live broadcast function enables the camera module to achieve the purpose of remote real-time monitoring or real-time sharing of live images, which can facilitate users to observe the status of pets in real time.

In actual applications, the Real-Time Messaging Protocol supported by the camera module can be used to push the stream to the third-party live broadcast platform servers. Specifically, the Real-Time Messaging Protocol is a network protocol for real-time data transmission, which is widely used in the field of video live broadcast. The device supports the Real-Time Messaging Protocol, which means that it can encapsulate and transmit the processed video stream according to the provisions of the Real-Time Messaging Protocol. The third-party live broadcast platform servers refer to the servers of the live broadcast platform built and operated by other companies or organizations. The application can push the video stream recorded by the camera module to the servers of these platforms and then distribute the live broadcast content to a large audience through the platforms' services. Users can take advantage of the powerful functions and broad user base of third-party live broadcast platforms to achieve more extensive video dissemination and interaction.

Preferably, the pet management system further includes a global position system module. The global position system module includes a global position system positioner for determining position.

Preferably, the pet management system further includes a voice recognition module. The voice recognition module includes a microphone used to collect the pet's sounds and a speaker used to play prerecorded audio recordings.

It should be noted that prerecorded audio recordings refer to some audio recordings that the user has recorded in advance through the application, such as audio recordings to call the pet back, audio recordings to soothe the pet, or audio files that simulate the pet's sounds, etc. The user can write the prerecorded audio recordings into the controller of the pet collar 1 through the application and control the speaker to play the specified audio recordings.

After the microphone collects the pet's sounds, it will be uploaded to the controller. The controller will identify the pet's sounds and determine whether the pet's sounds are abnormal. If the pet's calls are abnormal, the controller will control the camera module to record videos and simultaneously upload the recorded videos to the application to remind the user to pay attention.

In order to extend the battery life of the pet management system of this embodiment, this embodiment adopts a low-power design. Specifically, the detection module 2 also includes a motion sensor. When the motion sensor detects an abnormal activity speed, or when the voice recognition module monitors abnormal sounds, the controller will receive warming signals. When the pet's position has not changed and the pet's sounds are not abnormal, the global position system module and the camera module are in standby mode. When the detection module 2 detects that the pet is in an abnormal activity speed, then an abnormal signal is sent to the controller. The controller starts the global position system positioner for determining position and turns on the camera module to take photos and record videos.

A battery module is arranged inside the pet collar. The battery module is used to provide an operation voltage for each module of the pet management system. Assuming that the battery capacity in the battery module is 3000 ampere per hour, if multiple modules of the pet management system are in working state for a long time, the battery module can only work for ten hours before the power is exhausted. However, this embodiment can solve the power consumption problem through the low-power design. The battery module can work for seven days without frequent charging.

Preferably, the pet management system further includes an interaction module, which includes a feeder, a toy and an automatic door. The feeder, the toy and the automatic door are respectively provided with a Bluetooth chip, and the feeder, the toy and the automatic door are connected to the controller through the wireless transmission module. The user can control the controller through an application, thereby controlling the feeder, the toy and the automatic door.

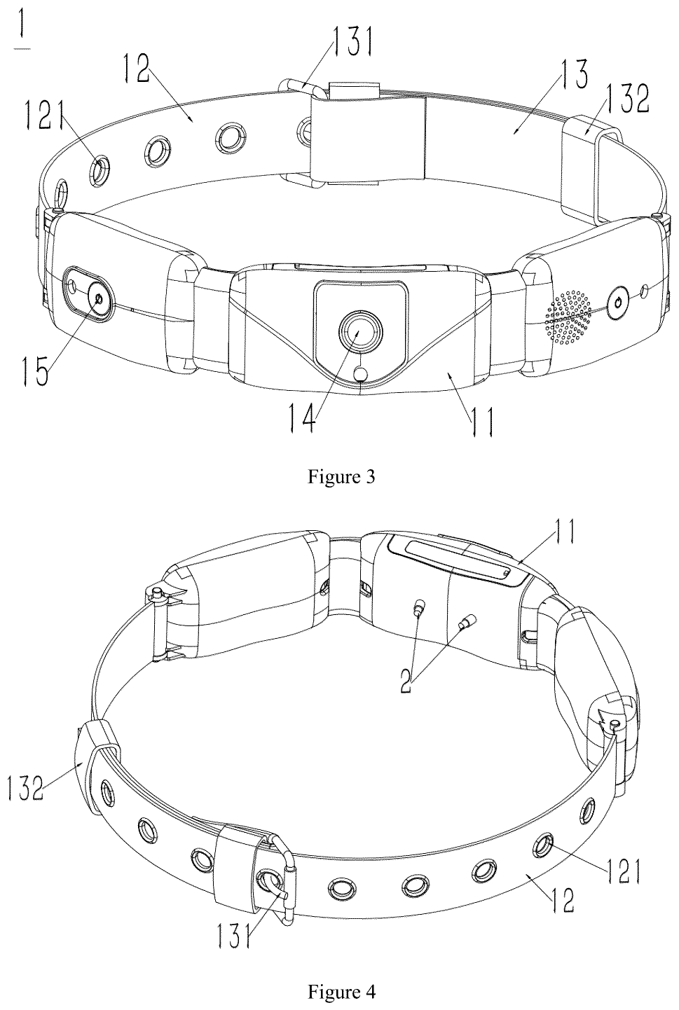

Referring to FIGS. 3 to 4, which are schematic diagrams of a pet collar 1 provided in this embodiment. The pet collar 1 includes a main body 11, a first strap 12 and a second strap 13. The first strap 12 and the second strap 13 are arranged on the two sides of the main body 11. The first strap 12 is provided with a plurality of evenly distributed connection holes 121 along its length direction. The second strap 13 is provided with a connection buckle 131 and a fixing buckle 132. The connection buckle 131 can be inserted into any one of connection holes 121 to have the first strap 12 and the second strap 13 connected. The fixing buckle 132 is used to fix the first strap 12.

The controller, the voice recognition module, the camera module, the global position system module and the wireless transmission module mentioned above are all arranged inside the main body 11. The interaction module and the pet collar mentioned above are arranged in the coverage area of the Bluetooth chip.

Understandably, by designing a plurality of connection holes 121, the connection position of the second strap 13 and the first strap 12 can be adjusted. Therefore, the pet management system of the present invention is suitable for pets with different neck sizes.

The camera module includes a camera 14, which is exposed on the surface of the pet collar 1. When the pet wears the pet collar 1, the camera 14 is located in front of the pet's neck, so as to record videos or take photos from the first perspective of the pet.

The voice recognition module is arranged on one side of the camera 14 and on one side of the pet's neck, so as to collect the pet's sounds and play prerecorded audio recordings to attract the pet's attention.

A control switch 15 is arranged on another side of the camera 14. The controller is arranged inside the pet collar 1. The control switch 15 is used to turn on or turn off the controller.

It could be understood that under the guidance of the above embodiments, those skilled in the field can combine various implementation methods in the above embodiments to obtain technical solutions of multiple implementation methods.

The above description is only a preferred embodiment of the present invention and is not to limit the present invention. Any modifications, equivalent substitutions and improvements made within the spirit and principles of the present invention should be included in the protection scope of the present invention.

1. A pet management system comprises a pet collar, which is provided with a controller, a wireless transmission module and a detection module, wherein the controller is electrically connected to the wireless transmission module and the detection module; the controller is connected to a terminal device through the wireless transmission module; the detection module is used to monitor real-time health condition of pets.

2. The pet management system according to claim 1, wherein the pet management system also comprises a camera module, which is electrically connected to the controller; and the controller is provided with a timing module used to turn on or turn off the camera module.

3. The pet management system according to claim 1, wherein the pet management system comprises a global position system module, which includes a global position system positioner for determining position.

4. The pet management system according to claim 3, wherein the pet management system also comprises a voice recognition module, which comprises a microphone used to collect the pet's sounds and a speaker used to play prerecorded audio recordings.

5. The pet management system according to claim 1, wherein the pet management system comprises an interaction module, which comprises a feeder, a toy and an automatic door; wherein the feeder, the toy and the automatic door are respectively provided with a Bluetooth chip, and the feeder, the toy and the automatic door are connected to the controller through the wireless transmission module.

6. The pet management system according to claim 1, wherein the pet collar comprises a main body, a first strap and a second strap; the first strap and the second strap are arranged on two sides of the main body; the first strap is provided with a plurality of evenly distributed connection holes along its length direction; the second strap is provided with a connection buckle and a fixing buckle; the connection buckle can be inserted into any one of the connection holes to have the first strap and the second strap connected; the fixing buckle is used to fix the first strap.

7. The pet management system according to claim 2, wherein the camera module comprises a camera exposed on a surface of the pet collar; the camera is located in front of the pet's neck when a pet wears the pet collar so as to record videos or take photos from a first perspective of the pet.

8. The pet management system according to claim 4, wherein the detection module also comprises a motion sensor; when the motion sensor monitors an abnormal activity speed, or when the voice recognition module monitors an abnormal sounds, the controller will receive warming signals.
